(19) United States
(12) Patent Application Publication
(10) Pub. No.: US 2026/0346521 A1
(43) Pub. Date: Nov. 5, 2026

(54) CLAMPING UNIT FOR AN INJECTION MOLDING MACHINE

(71) Applicant: Milacron India Private Limited, Ahmedabad (IN)

(72) Inventors: Darshit V Shah, Ahmedabad (IN); Atin Tandon, Batavia, OH (US)

(21) Appl. No.: 19/632,955

(22) Filed: Mar. 30, 2026

(30) Foreign Application Priority Data
Apr. 2, 2025 (IN) 202521032713

(51) Int. Cl. B29C 45/67; B29C 45/82

(52) U.S. Cl. CPC B29C 45/67; B29C 45/82; B29C 2045/824

(57) ABSTRACT

A clamping unit for an injection molding machine comprises a stationary platen, a moving platen, tie rods, at least one first cylinder in fluid communication with a fluid system to move said moving platen in an axial direction towards and away from the stationary platen, at least one second cylinder in fluid communication with the fluid system to provide a clamping force, and the fluid system.

### CROSS-REFERENCE TO RELATED APPLICATION

The present application claims the priority benefit of Indian Patent Application number 202521032713, which was filed on Apr. 2, 2025, and which is incorporated herein by reference in its entirety.

### TECHNICAL FIELD

The present invention relates to an injection molding machine. Specifically, the present invention relates to a plastic injection molding machine. More specifically, the present invention relates to a clamping unit for injection molding.

### BACKGROUND

Generally, injection molding machines are equipped with mold that helps in casting material into desired shape. Primarily, injection molding machine is divided in two halves that are known as a clamping unit and an injection unit.

The clamping unit in injection molding machine is to develop clamping force on two halves of mold. The clamping unit comprising a stationary platen, at least one moving platen, plurality of a tie bars and at least one clamping cylinder assembly. Generally, the molds used in molding machines are manufactured in two halves. A first half of the mold is mounted on the stationary platen and a second half of the mold is mounted on the moving platen. Vertical and horizontal distance between tie bars and distance between moving and stationary platen are important factors to determine size of mold that can fit in clamping unit. With the help of a high-speed cylinders (a first cylinder), the moving platen half is moved towards the stationary platen. The moving platen moves until the first half mold comes in physical contact with the second half mold. Once both the mold halves are in contact, a clamping cylinder (a second cylinder) is supplied with fluid under pressure to build a clamping force. The Clamping force is also referred to as tonnage force.

During clamping force build function both first and second cylinder see displacement in same direction where clamping force is built, see displacement Δx and Δa shown in FIG. 4. During injection function, depending on size of the second cylinder, fluid volume stored inside hoses, pipes and manifold assembly, the second cylinder will see small amount of displacement along with the first cylinders and moving platen in opposite direction of the clamping force. Such small displacement of moving platen can generate minor material flash or short shot on end product. Typically, the clamping cylinder can be one of two types, i.e., a long stroke clamping cylinder and a short stroke clamping cylinder.

The clamping unit having the long stroke clamping cylinder requires large volume of fluid to induce the clamping force. Due to the large volume of fluid in the long stroke clamping cylinder, demand for energy to induce clamping force is high and takes longer period to build the required clamping force.

The clamping unit having the short stroke clamping cylinder requires lesser amount fluid to induce the clamping force. The requirement of lesser volume of fluid to build the clamping force, helps in reduction in consumption of energy and time to build clamping force in the clamping cylinder. However, due to the lesser volume of fluid the clamping unit, the clamping unit is prone to the clamping force intensification due to counter force from injecting material inside mold from the injection unit.

US patent publication 2020/0147848A1 discloses a closing unit for a shaping machine. The closing unit is of 2-platen corner short stroke clamping cylinder. An accumulator placement is known from US2020/0147848A1 where pressurized oil potential energy released during clamping force reduction function is stored inside the accumulator and this stored energy can be utilized to run nut locks and core pull as partial recovery of energy. However, there is limitation of cavitation in piston area of clamping cylinder during clamp force reduction function. Due to displacement Δs of clamping cylinder, there is higher volume of oil required to be added inside piston area of cylinder to avoid cavitation. Since oil inside cylinder annulus area is added to the accumulator, there is need of external source of oil volume to be connected to piston area of cylinder which will consume energy and reduce overall recovered energy. Depending on size of clamping unit and cylinder, when cylinder size and stroke are relatively small, there is quite less volume of oil can be added to an accumulator which would not be enough to run core pull and nut locks.

Another type of the clamping unit can be a 3-platen centre short stroke clamping cylinder. Both types of clamping units are prone to clamping force intensification due to counter force from injecting material inside mold by the injection unit.

Therefore, there is a need in art to provide a clamping unit which dampens the clamping force intensification in the clamping cylinder and is capable of allowing the clamping to run larger clamp force requirement molds in smaller clamping force capacity units developed with larger vertical and horizontal distance between tie bars & larger distance between moving and stationary platen with having lesser amount of fluid in building clamping force. Furthermore, to increase return on investment of injection molding machines by allowing the higher clamping force requirement mold to run in injection molding machine having less clamping force capacity.

### OBJECTIVE OF INVENTION

An object of the present invention is to provide a clamping unit for an injection molding machine. Another object of the present invention is to provide a clamping unit for an injection molding machine which can dampen the clamping force intensification in a clamping cylinder (second cylinder). Yet another object of the present invention is to provide a clamping unit for an injection molding machine which is capable of running higher clamping force requirement mold in smaller size of clamping unit.

### SUMMARY

An injection molding machine is divided into two halves that are known as a clamping unit and an injection unit.

The clamping unit comprising at least one stationary platen, at least one moving platen, plurality of a tie bars, at least one first cylinder and at least one second cylinder. Generally, a mold used in molding machines are in two halves. A first half of the mold is mounted on the stationary platen and a second half of the mold is mounted on the moving platen, or vice versa. Vertical and horizontal distance between tie bars and distance between moving and stationary platen are important factors to determine size of mold that can fit in clamping unit. With the help of the first cylinder, the moving platen is moved towards the stationary platen. The moving platen moves until the first half mold comes in physical contact with the second half mold. Once both the mold halves are in contact, the second cylinder is supplied with a fluid under pressure to build a clamping force by means of a fluid system. An accumulator gets charged to fluid pressure required to build preset a clamp force.

During the injection phase, due to plastics melting a counterforce inside the molds acting against the clamping force in a second piston side of the second cylinder, fluid pressure sees pressure intensification. However, due to adequate sizing of the accumulator this excess force exerted by injection is absorbed by the accumulator as an additional compressed fluid volume. The accumulator helps to dampen possible pressure spike and amount of clamp force intensification seen during injection phase.

After injection phase is completed, the accumulator is isolated from the second cylinder. The accumulator pressure is reduced up to 60-80% of preset clamp force with the help of a third pressure transducer and an eight valve. The accumulator pressure reduction % number can be set between the range of 60-80% of pressure required to build maximum clamp force.

The clamp force intensification is dampened by adequate sizing of the accumulator and control logic of the fluid system. The clamp force is intensified due to the counter force from pressurized melted material inside mold. Due to injection, the counter force in opposite direction of the clamping force, the accumulator allows to absorb the fluid from the second piston side of the second cylinder to dampen the pressure intensification in the second cylinder.

Depending on plastics material type, grade and other injection processing parameters, the clamping unit for the injection molding machine can run higher clamping force requirement mold in 5-15% smaller size of clamping unit.

### BRIEF DESCRIPTION OF THE FIGURES

FIG. 1 is a perspective view of an embodiment of a 3-platen clamping unit according to the present invention;

FIG. 2 is a perspective view of another embodiment of the 3-platen clamping unit according to the present invention;

FIG. 3 is a perspective view of an embodiment of a 2-platen clamping unit according to the present invention;

FIG. 4 is a schematic view of a fluid system of the clamping unit;

FIG. 5 is a schematic view of a representation of a fluid system of the clamping unit;

FIG. 6 is a schematic view of operational fluid flow during an injection phase in the fluid system of the clamping unit as embodied in FIG. 5;

FIG. 7 is a schematic view of operational fluid flow during a clamping force release phase in the fluid system of the clamping unit as embodied in FIG. 5;

FIG. 8 is a schematic view of another embodiment of a fluid system of the clamping unit;

FIG. 9 is a schematic view of operational fluid flow during the injection phase in the fluid system of the clamping unit as embodied in FIG. 8; and

FIG. 10 is a schematic view of operational fluid flow during the clamping force release phase in the fluid system of the clamping unit as embodied in FIG. 8.

### DETAILED DESCRIPTION OF ILLUSTRATIVE EMBODIMENTS

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the scope of the invention.

Throughout this specification, the use of the word “comprise” and variations such as “comprises” and “comprising” may imply the inclusion of an element or elements not specifically recited.

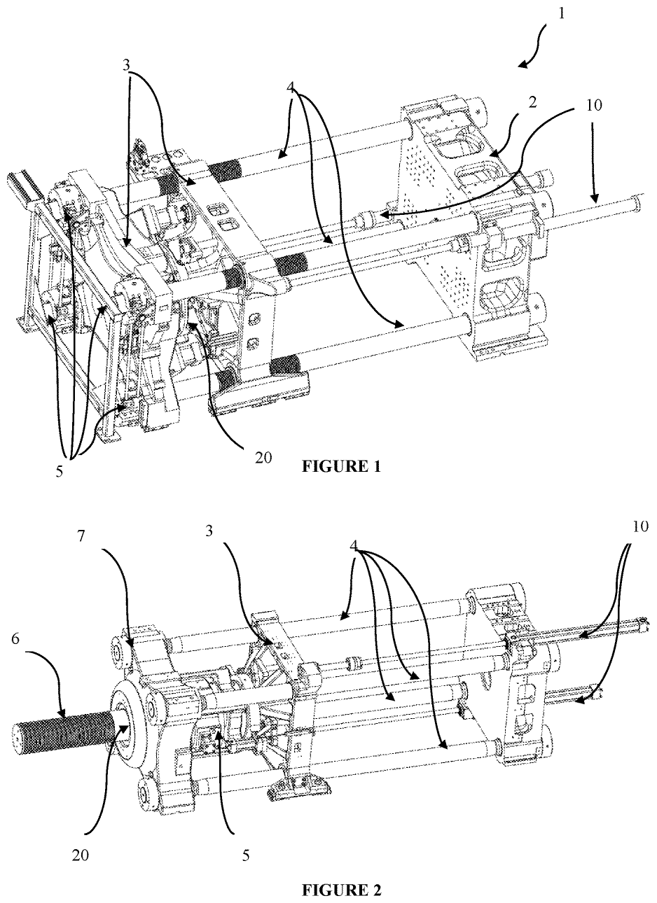

FIG. 1 shows an embodiment of a clamping unit (1A). The clamping unit (1A) comprising a stationary platen (2) and two moving platen (3). The moving platens (3) are configured in a stacked manner. A first half of mold is coupled to the stationary platen (2) and a second half of mold is coupled to the moving platen (3). The moving platens (3) and the stationary platens (2) having symmetrical recesses to accommodate a plurality of tie rods (4). In an exemplified embodiment, the plurality of tie rods (4) are 4 tie rods (4). The tie rods (4) are configured to have external threads for locking by means of a locking assembly (5). The moving platens (3) are configured to move along the axial length of the tie rods (4). A plurality of first cylinders (10) enables the movement of the moving platen (3) towards and away from the stationary platen (2), along the axial direction of the tie rods (4), until the first half mold and the second half mold are brought in contact with each other.

At least one second cylinder (20) is configured to provide clamping force (Fₛ). In an exemplified embodiment of FIG. 1, the clamping unit (1A) comprises one second cylinder (20) at the center of the moving platen (3). The first cylinders (10) and the second cylinder (20) are in a fluid communication with a fluid system (30).

FIG. 2 exemplifies another embodiment of a clamping unit (1B) of the injection molding machine. The clamping unit (1B) comprising the two stationary platens (2, 7) and the moving platen (3). The second cylinder (20) is positioned on the center of the stationary platen (7). The moving platen (3) and the stationary platens (2, 7) are having symmetrical recesses to accommodate a plurality of tie rods (4). The moving platen (3) is configured to move along the axial length of the tie rods (4). The moving platen (3) and threaded rod (6) are rigidly connected so they move together due to plurality of first cylinders (10). The plurality of first cylinders (10) enables the movement of the moving plate (3) towards and away from the stationary platen (2), along the axial direction of the tie rods (4), until the first half mold and the second half mold are brought in contact with each other. The locking assembly (5) is positioned in between and at the center of the stationary platen (7) to lock the moving platen (3) and threaded rod (6) when in mold open or mold closed position.

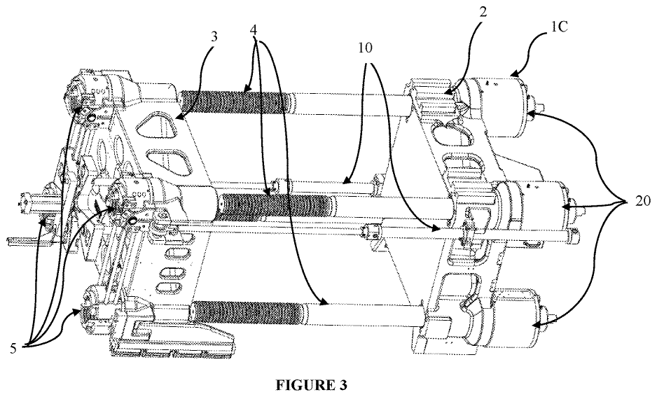

FIG. 3 exemplifies yet another embodiment of a clamping unit (1C) of the injection molding machine. The clamping unit (1C) comprises one stationary platen (2) and one moving platen (3). The first cylinders (10) are configured to move the moving platen (3) in axial direction along the tie rods (4) towards and away from the stationary platen (2). The plurality of second cylinders (20) are configured on corners of the stationary platen (2), to provide the clamping force (Fₛ).

The first cylinders (10) having a first piston side (11) and a first rod side (12), and the second cylinders (20) having a second piston side (21) and a second rod side (22).

The second cylinder (20) has construction where an area of the second piston side (21) is significantly higher than an area of the second rod side (22). The first cylinders (10) have construction where an area of the first piston side (11) is greater than an area of the first rod side (12). The area of the second piston side (21) is 4-8 times bigger than the area of the second rod side (22). The area of the second piston side (21) is 15-20 times bigger than the area of the first piston side (11). The area of the first piston side (11) is 1.5-2 times bigger than the area first rod side (12). The area relationship, then is described as the area of the second piston side (21)>the area of the second rod side (22)>the first piston side (11)>the area of the first rod side (12).

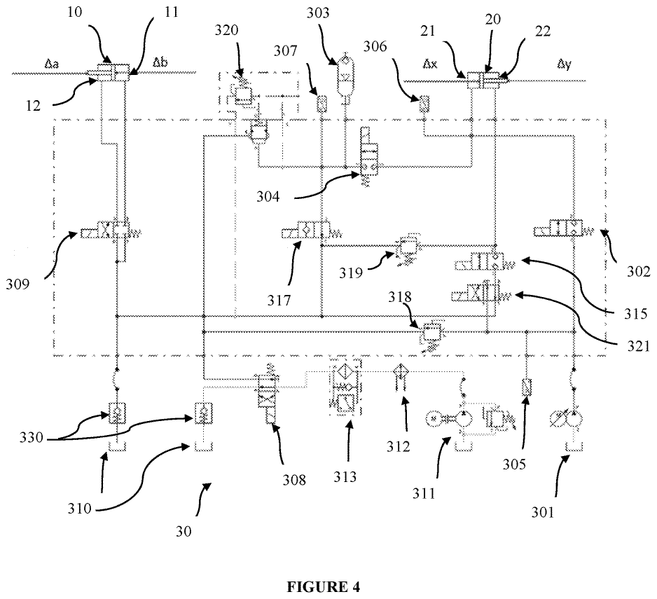

The first cylinders (10) and the second cylinders (20) are in a fluid communication with a fluid system (30). The fluid systems (30) are exemplified in the FIGS. 4 to 10.

FIG. 4 shows a generic representation of an exemplified embodiment of the fluid system. The fluid system (30) comprising, a first pump (301), a first valve (302), an accumulator (303), a second valve (304), and a control unit (not shown). The control unit capable of controlling or actuating the first pump (301), the first valve (302), the accumulator (303) and the second valve (304).

The control unit estimates a required clamping force (Fₛ) by multiplying pressure monitored by the second pressure transducer (306) with the area of the second piston side (21) of the second cylinder (20).

During a clamping phase the first pump (301) provides fluid to the second piston side (21) of the second cylinder (20) through the first valve (302) to build the clamping force (Fₛ). The accumulator (303) absorbs additional fluid from the second piston side (21) of the second cylinder (20) to dampen the pressure intensification due to injection of molten material during an injection phase. The accumulator (303) receives the additional fluid from the second cylinder (20) through the second valve (304).

In an embodiment, the accumulator (303) can be included or excluded from the fluid system (30) by means of the control unit. In an exemplified embodiment, if requirement of the clamping force set in control unit is smaller than 60% of the maximum clamping force capacity, the control unit isolates the accumulator (303) from the fluid system (30) through the second valve (304). In another exemplified embodiment, if requirement of the clamping force set in control unit is larger than 60% of the maximum clamping force capacity, the control unit includes the accumulator (303) to the fluid system (30) through the second valve (304).

The fluid system (30) includes a first pressure transducer (305), a second pressure transducer (306) and a third pressure transducer (307). The first pressure transducer (305) monitors the pressure of the fluid supplied through the first pump (301), the second pressure transducer (306) monitors fluid pressure in the second piston side (21) of the second cylinder (20), and the third pressure transducer (307) monitors fluid pressure in the accumulator (303). The first pressure transducer (305), the second pressure transducer (306) and the third pressure transducer (307) transmit the measured pressure to the control unit.

During clamping force build function, the control unit monitors the pressure difference between third pressure transducer (307) and the second pressure transducer (306). When the pressure difference is below a pre-settable value, the control unit actuates the second valve (304) to merge the accumulator (303) with the second piston (21). The pre-settable value is in a range of 5 bar to 25 bar. Pressure difference between the third pressure transducer (307) and the second pressure transducer (306) and monitoring time can be pre-settable with wide range of values in machine control unit for merging of the first pump (301) with accumulator (303) without any abnormal pressure spikes.

The fluid system (30) includes an eight valve (317), the control unit is capable of actuating and switching off the eight valve (317) to regulate the pressure of the accumulator (303). The control unit switches off the eight valve (317), when the displacement (Δy) due to injection counter force (Fi) intensifies clamping force (Fₛ) more than 15% of the maximum clamping force (Fₛ).

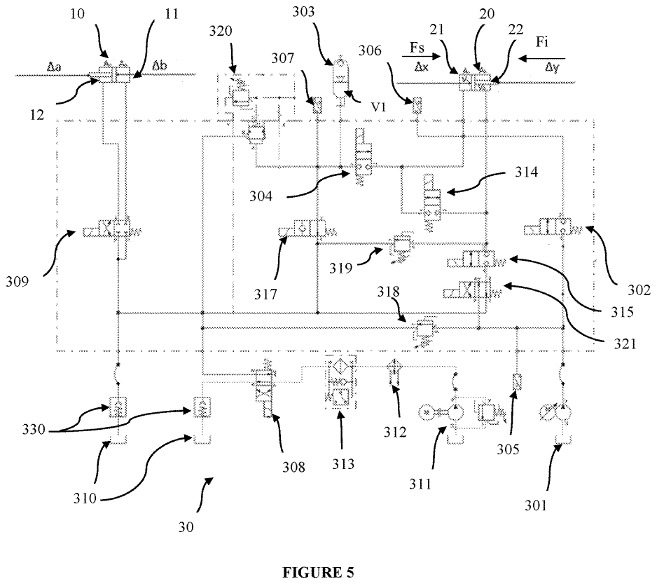

In an exemplified embodiment of the fluid system (30) is shown in FIG. 5-7. Below table 1 enumerates that various valves are actuated and switched-off of the fluid system (30) of the clamping unit during different phases of the injection molding machine.

TABLE 1

| | | VALVES |
|---|---|---|
| PHASE | VALVES ACTUATED | SWITCHED OFF |
| CLAMPING | First valve (302), Second | Fourth valve (308), |
| PHASE | valve (304)*, Third valve | Sixth valve (315) and |
| | (314), Fifth valve (309), | Ninth valve (321) |
| | and Eight valve (317) | |
| INJECTION | Second valve (304), | First valve (302), |
| PHASE | Third valve (314), Fourth | Sixth valve (315) and |
| | valve (308)*, Fifth valve | Ninth valve (321) |
| | (309), and Eight valve | |
| | (317) | |
| ACCUMULATOR | Third valve (314), Fifth | First valve (302), |
| ISOLATION | valve (309), and Eight | Second valve (304), |
| | valve (317) | Fourth valve (308), |
| | | Sixth valve (315) and |
| | | Ninth valve (321) |
| CLAMPING | Third valve (314), Fifth | First valve (302), |
| FORCE | valve (309), Sixth valve | Second valve (304), |
| RELEASING | (315) and Eight valve | Fourth valve (308) and |
| PHASE | (317) | Ninth valve (321) |

*valve actuates when a condition is met/triggered

During the clamping phase, when fluid supplied by the first pump (301) is allowed to pass through the first valve (302). Due to the pump of fluid to the second piston side (21) the clamping force (Fₛ) is provided and there will be displacement (Δx) in the second cylinder (20) and displacement (Δa) the first cylinder (10). The second cylinder (20) is moved in a forward direction with displacement (Δx) as fluid is being supplied in the second piston side (21) the third valve (314) is actuated to return fluid from the second rod side (22) of the second cylinder (20) to the second piston side (21) of the second cylinder (20).

During the very first cycle, the accumulator (303) will have stored pressure energy due to nitrogen pre-charge pressure. For the next subsequent cycles, the accumulator (303) will have stored pressure energy of nitrogen pre-charge pressure or residual energy left after reducing the accumulator (303) pressure post clamping force release phase. In an exemplified embodiment, during clamping force (Fₛ) build up function the control unit estimates the differential of pressure between the third pressure transducer (307) and the second pressure transducer (306) on quicker sampling rate <10 msec. Once differential pressure between the third pressure transducer (307) and the second pressure transducer (306) is less than 25 bar for monitoring time of 20 msec, the second valve (304) is actuated to merge the accumulator (303) with the second piston side (21) of the second cylinder (20). Pressure difference between the third pressure transducer (307) and the second pressure transducer (306) and monitoring time can be pre-settable with wide range of values in machine control unit for merging of the first pump (301) with accumulator (303) without any abnormal pressure spikes.

After merging of the accumulator (303) there is sudden increase in effective fluid volume (Veff). Veff is described as shown below.

Veff=Vc+Vb+V1

Vc is volume of fluid in the second piston side (21) of the second cylinder (20), Vb is volume of fluid in the second rod side (22) of the second cylinder (20), and V1 is volume of fluid stored inside the accumulator (303) at gas pre-charge pressure or residual leftover after accumulator (303) pressure reduction through eighth valve (317).

Due to increase in effective volume (Veff), there will be more amount of compressed fluid to be added to reach up to preset clamp force (Fₛ). As clamping force (F) reaches near a pre-set clamping force value (Fₛ), the control unit will switch off the first valve (302) to stop supplying fluid from the first pump (301) to prevent clamping force (Fₛ) seeing large overshoot above the pre-set clamping force.

The control unit actuates the first valve (302) to supply fluid to the second piston side (21) of the second cylinder (20) during the clamping phase, and the control unit switching off the first valve (302) when the pressure measured by the second pressure transducer (306) is equivalent to the pre-set pressure. The pre-set pressure can be set by the user based on the requirement to produce good part from mold.

The second cylinder (20) has a position sensor (not shown), said position sensor capable of measuring the position of the piston in the second cylinder (20). The position sensor is configured to transmit the measured position of the piston of the second cylinder (20) to the control unit. The control unit stores the measured position of the second cylinder (20) after preset clamping force is built and it monitors position before an injection phase and during the injection phase. After clamping force (Fₛ) is built, there will be settling time of ~250-400 msec is given post which the control unit will store the second cylinder (20) piston position and start monitoring piston displacement deviation compared to stored position.

The fluid is trapped under pressure in the second cylinder (20) to maintain clamping force (Fₛ). The control unit is monitoring both clamping force and clamping cylinder piston absolute position. Post the clamping phase, injection phase will take place where the second valve (304), the third valve (314), the fourth valve (308), the fifth valve (309), and the eight valve (317) are actuated. The injection counter force (Fi) will be acting in opposite direction to clamping force (Fₛ) on the second cylinder (20). Due to the injection counter force (Fi), the second cylinder (20) & the first cylinder (10) will have displacement (Δy) and (Δb) respectively. Due to displacement (Δy) of the second cylinder (20), there is intensification in clamping force (Fₛ) as fluid is kept trapped under pressure in both the second piston side (21) and the second rod side (22) of the second cylinder (20).

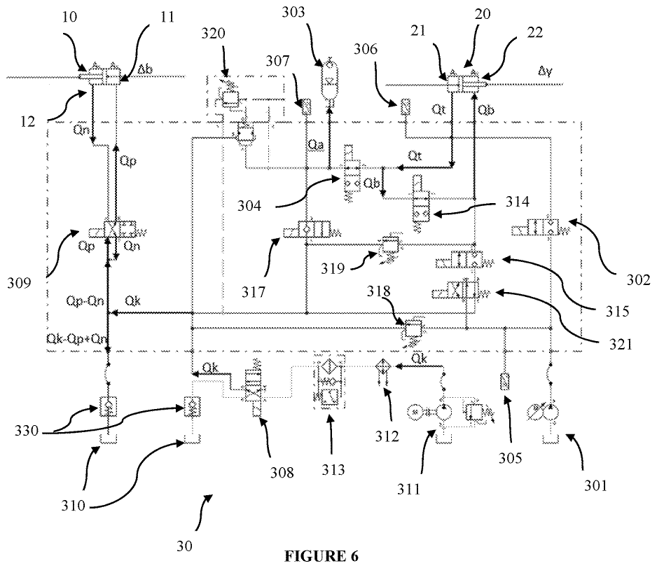

As shown in FIG. 6, the displacement (Δy) in the second cylinder (20) will generate transient flow Qt going out from the second piston side (21) of the second cylinder (20). Depending on an area ratio of the second piston side (21) to the second rod side of the second cylinder (20), the fluid flow Qb will be added to the second rod side (22) through the third valve (314). The third valve (314) helps to avoid cavitation in the second rod side (22) of the second cylinder (20) due to displacement (Δy).

The accumulator (303) will be absorbing remaining amount of fluid flow Qa (Qt-Qb) as an additional compression volume due to displacement (Δy) on the second cylinder (20). Overall, there will be increase in clamping force due to displacement (Δy), but it is dampened with the help of the accumulator (303) and cavitation in the second rod side (22) of the second cylinder (20) is being avoided.

During injection function, the piston in the second cylinder (20) will move to different position compared to position recorded and monitored by the control unit and it will trigger output to actuate the fourth valve (308). The first cylinder (10) will also undergo displacement (Δb) due to displacement (Δy) of the second cylinder (20). The first cylinder (10) has construction where area of the first piston side (11) is greater than the area of the first rod side (12). Due to displacement (Δb) in first cylinder (10), fluid flow Qn is pushed out of first rod side (12) of the first cylinder (10).

Based on area ratio between the first piston side (11) to the first rod side (12) of the first cylinder (10), fluid flow (Qp) must flow into the first piston side (11) of the first cylinder (10) to avoid cavitation in the first piston side (11) due to displacement (Δb). The fourth valve (308) will divert fluid flow (Qk) to the fifth valve (309). The fluid flow (Qk) is divided where fluid flow (Qp-Qn) will flow to the fifth valve (309). The fluid flow Qn coming out of the first rod side (12) will add up into flow (Qp-Qn) to get desired oil flow (Qp) for piston of the first cylinder (10). Remaining fluid flow (Qk-Qp) along with the returning fluid flow (Qn) will return to the reservoir (310) through the check valve (330).

Before clamping force release function, the control unit switches off the second valve (304) to prevent complete energy loss of the accumulator (303) and actuates the third valve (314), the sixth valve (315). The fluid (Qd) from the second piston side (21) of the second cylinder (20) is released and passes through the third valve (314). A part of the released fluid (Qb) from the third valve (314) is returned to the second rod side (22) of the second cylinder (20) and a second part of the released fluid (Qd-Qb) is sub-divided into a first sub-divided part of fluid (Qp) is supplied to the first piston side (11) of the first cylinder (10) through the fifth valve (309), and a returning fluid (Qn) through the fifth valve (309) displaced from the first rod side (12) of the first cylinder (10) and a second sub-divided part of the fluid (Qd-Qb-Qp) from the third valve (314) is returned to the reservoir (310) through the sixth valve (315), the ninth valve (321) and the check valve (330).

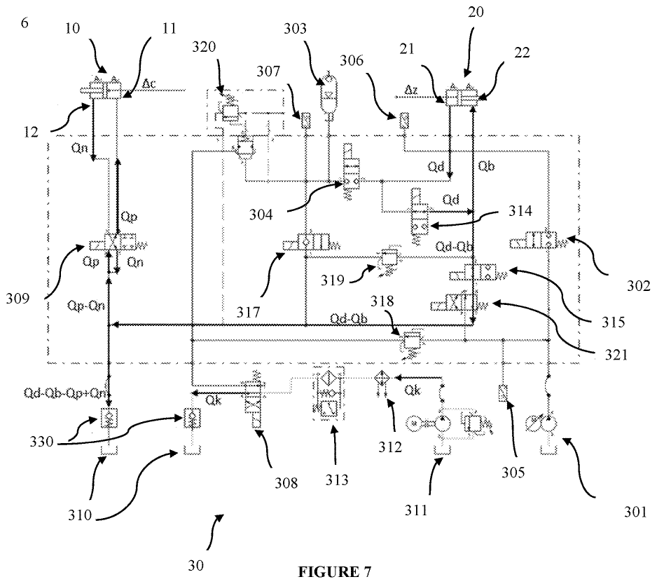

As shown in the exemplified embodiment of FIG. 7, after injection phase is completed, the second valve (304) and the fourth valve (308) are switched off. The fourth valve (308) will divert flow (Qk) to reservoir (310) through check valve (330). Switching off the second valve (304) will isolate the accumulator (303) from the second piston side (21) of the second cylinder (20). If the accumulator (303) is not isolated before clamp force releasing phase, then stored energy inside the accumulator (303) will be lost completely.

During clamp force releasing phase the third valve (314), the fifth valve (309), the sixth valve (315) and the eight valve (317) are actuated. The sixth valve (315) will release high pressure fluid from the second piston side (21) to the second rod side (22) of the second cylinder (20) through third valve (314) and to the reservoir (310) via the sixth valve (315) the ninth valve (321) and check valve (330). As clamping force is released, the second cylinder (20) will have displacement (Δz) due to release of compressed fluid volume, tie rods length contraction and elastics deformation reversal of platens and molds. Due to displacement (Δz) of the second cylinder (20), the first cylinder (10) will have a displacement (Δc). Due to displacement (Δz) of the second cylinder (20), there is transient clamp de-compress flow (Qd) going out of the second piston side (21) of the second cylinder (20). The fluid flow (Qd) is passed through the third valve (314) and added to the second rod side (22) of the second cylinder (20). Based on the area ratio between the second piston side (21) to the second rod side (22) of the second cylinder (20), fluid flow (Qb) must be added to the second rod side (22) of the clamping cylinder (20) to avoid cavitation in the second rod side (22) of the second cylinder (20). The fluid flow (Qb) is added from fluid flow (Qd) and remaining fluid flow (Qd-Qb) is passed through the sixth valve (315) and the ninth valve (321). Thereafter, fluid flow (Qd-Qb) is diverted to the fifth valve (309) and the reservoir (310). The first cylinder (10) has displacement (Δc) which forces fluid flow (Qn) flowing out of the first rod side (12). Depending on area ratio of first piston side (11) to the first rod side (12) of the first cylinder (10), fluid flow (Qp) must be added in the first piston side (11) to avoid cavitation due to displacement (Δc). Out of the fluid flow (Qd-Qb), the fluid flow (Qp) is added to the fifth valve (309). The Remaining fluid flow (Qd-Qb-Qp) along with a returning fluid (Qn) from the first cylinder (10) through the fifth valve (309) is returned to the reservoir (310) through check valve (330).

After clamp force releasing phase, the accumulator (303) pressure reduction will be controlled by means of the eight valve (317) and the third pressure transducer (307). Based on the pre-set clamping force (Fₛ) and area of the second piston side (21), a clamping pressure (Pc) is calculated by the control unit. The accumulator (303) pressure can be reduced up-to 60-80% of the clamping pressure (Pc).

After releasing phase, pressure inside the accumulator (303) which is remaining as a residual energy, is capable of being used in next machine cycle to build clamping force (Fₛ). The accumulator (303) having the residual energy as remaining pressure helps to save amount of energy and time required to build set clamping force (Fₛ) during next machine cycle.

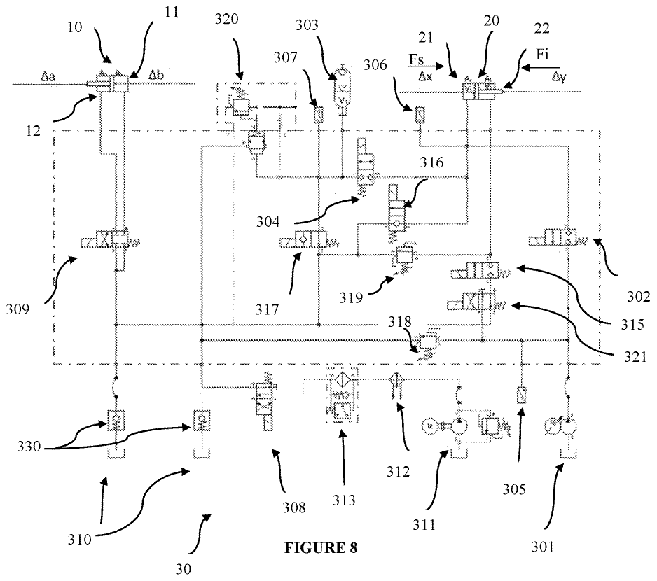

In an exemplified embodiment of the fluid system (30) is shown in FIG. 8-10. Below table 2 enumerates that various valves are actuated and switched-off of the fluid system (30) of the clamping unit during different phases of the injection molding machine.

TABLE 2

| | | VALVES |
|---|---|---|
| PHASE | VALVES ACTUATED | SWITCHED OFF |
| CLAMPING | First valve (302), Second | Fourth valve (308), |
| PHASE | valve (304)*, Fifth valve | Seventh valve (316) and |
| | (309), Sixth valve (315) | Ninth valve (321) |
| | and Eight valve (317) | |
| INJECTION | Second valve (304), | First valve (302), |
| PHASE | Fourth valve (308)*, | Seventh valve (316) and |
| | Fifth valve (309), Sixth | Ninth valve (321) |
| | valve (315) and Eight | |
| | valve (317) | |
| ACCUMULATOR | Fifth valve (309), Sixth | First valve (302), Second |
| ISOLATION | valve (315) and Eight | valve (304), Fourth valve |
| | valve (317) | (308), Seventh valve |
| | | (316) and Ninth valve |
| | | (321) |
| CLAMPING | Fifth valve (309), Sixth | First valve (302), Second |
| FORCE | valve (315), Seventh | valve (304), Fourth valve |
| RELEASING | valve (316) and Eight | (308) and Ninth valve |
| PHASE | valve (317) | (321) |

*valve actuates when a condition is met/triggered

During clamping phase, fluid is added to the second piston side (21) of the second cylinder (20) through the first valve (302) from the first pump (301). Due to the pump of fluid to the second piston side (21) the clamping force (Fₛ) is provided and there will be displacement (Δx) in the second cylinder (20) and displacement (Δa) in the first cylinder (10). Due to displacement (Δx) in the second cylinder (20), return fluid flow from the second rod side (22) of the second cylinder (20) is sent to the reservoir (310) through the sixth valve (315) the ninth valve (321) and check valve (330).

During the very first cycle, the accumulator (303) will have stored pressure energy due to nitrogen pre-charge pressure. For the next subsequent cycles, the accumulator (303) will have stored pressure energy of nitrogen pre-charge pressure or residual energy left after reducing the accumulator (303) pressure post clamping force release phase. In an exemplified embodiment, during clamping force (Fₛ) build up function the control unit estimates the differential of pressure between the third pressure transducer (307) and the second pressure transducer (306) on quicker sampling rate <10 msec. Once differential pressure between the third pressure transducer (307) and the second pressure transducer (306) is less than 25 bar for monitoring time of 20 msec, the second valve (304) is actuated to merge the accumulator (303) with the second piston side (21) of the second cylinder (20). Pressure difference between the third pressure transducer (307) and the second pressure transducer (306) and monitoring time can be pre-settable with wide range of values in machine control unit for merging of the first pump (301) with accumulator (303) without any abnormal pressure spikes.

For the embodiments in FIGS. 5-7, effective clamping force can be described as—Effective clamping force Fe=(Clamping pressure)*([Area of the second piston side]−[Area of the second rod side]).

For the embodiments in FIGS. 8-10, since fluid from the second rod side (22) of the second cylinder (20) is returned to the reservoir (310) through check valve (330), effective clamping force (Fₑ) can be described as shown below.

Effective clamping force (Fₑ)=(Clamping pressure)*(Area of the second piston side). Here, counterforce due to check valve (330) spring cracking pressure can be ignored because its value will be negligible compared to clamping pressure.

The first valve (302), the fifth valve (309), the sixth valve (315) and the eight valve (317) are kept actuated while building clamping force. The second valve (304) merges the accumulator (303) with the second piston side (21) of the second cylinder (20) during clamping phase. The accumulator (303) merging methodology and logic is same between both the exemplified embodiments as shown in FIGS. 5-7 and 8-10. After merging of the accumulator (303) during the clamping phase, there is sudden increase in effective oil volume Veff. Veff is described as shown below.

Veff=Vc+V1

Vc is volume of fluid in the second piston side (21) of the second cylinder (20), and V1 is volume of fluid stored inside the accumulator (303) at gas pre-charge pressure or residual leftover after accumulator (303) pressure reduction through eighth valve (317)

In this exemplified embodiment, Veff is less compared to the exemplified embodiment of FIG. 5 because volume the Vb is not accounted in building clamping force Fₛ. Due to that clamping will require less compression fluid volume to reach clamping force (Fₛ).

The control unit actuates the first valve (302) to supply fluid to the second piston side (21) of the second cylinder (20) during the clamping phase, and the control unit switching off the first valve (302) when the pressure measured by the second pressure transducer (306) is equivalent to the pre-set pressure. The pre-set pressure can be set by the user based on the requirement to produce good part from mold.

The second cylinder (20) has a position sensor, said position sensor capable of measuring the position of the piston in the second cylinder (20). The position sensor is configured to transmit the measured position of the piston of the second cylinder (20) to the control unit. The control unit stores measured position of the second cylinder (20) after preset clamping force is built and it monitors position before an injection phase and during the injection phase. After clamping force (Fₛ) is built, there will be settling time of ~250-400 msec is given post which the control unit will store the second cylinder (20) piston position and start monitoring piston displacement deviation compared to stored position.

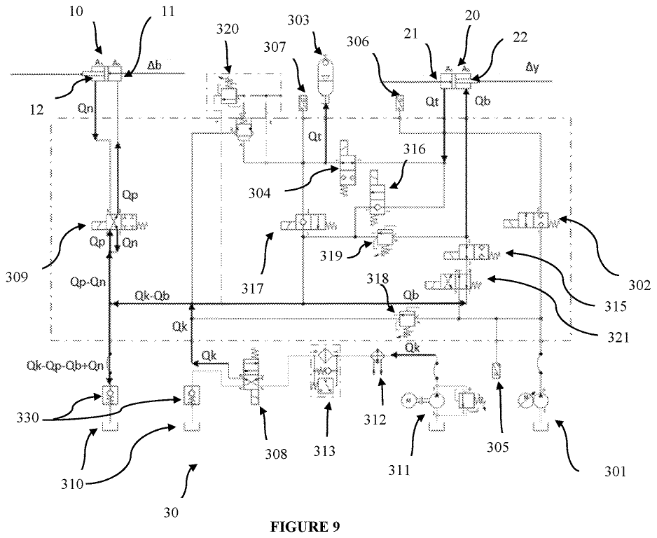

The fluid is trapped under pressure in the second cylinder (20) to maintain clamping force (Fₛ). The control unit is monitoring both clamping force and clamping cylinder piston absolute position. Post the clamping phase, the injection phase takes place. During injection phase the second valve (304), the fourth valve (308), the fifth valve (309), the sixth valve (315) and the eight valve (317) are actuated. As shown in FIG. 8, the injection counter force (Fi) will be acting in opposite direction to the clamping force (Fₛ). Due to the injection counter force (Fi), the second cylinder (20) and the first cylinder (10) will have displacements in the direction (Δy) and (Δb) respectively. During injection phase, displacement in direction (Δy) will move the second cylinder (20) to different position compared to position recorded and monitored by the control unit and the control unit actuates the fourth valve (308). By actuating the fourth valve (308), the fluid from the second pump (311) flow (Qk) is diverted to the fifth valve (309) and to the sixth valve (315) through the ninth valve (321). As shown in FIG. 9, due to the displacement (Δy) on the second cylinder (20), there is transient fluid flow (Qt) coming out of the second piston side (21) of the second cylinder (20). The second valve (304) will divert entire transient fluid flow Qt to the accumulator (303) as an additional compression volume inside the accumulator (303) which will dampen the pressure intensification in the second piston side (21) of the second cylinder (20).

The fluid system (30) shown in FIG. 9, to avoid cavitation in the second rod side (22) of the second cylinder (20) due to the displacement (Δy), the fluid flow (Qb) is added from the second pump (311) total flow (Qk) and will be passed through the ninth valve (321) and the sixth valve (315). Due to the displacement (Δy) in the second cylinder (20), the first cylinder (10) will have displacement (Δb). Due to displacement (Δb) in the first cylinder (10), the fluid flow Qn is pushed out from the first rod side (12) of the first cylinder (10). Based on area ratio of the first piston side (11) to the first rod side (12) of the first cylinder (10), the fluid flow (Qp) must flow into the first piston side (11) to avoid cavitation in the first piston side (11) due to displacement (Δb). The fluid flow (Qk) is divided where the fluid flow (Qb) will flow to the ninth valve (321) and sixth valve (315) to reach to the second rod side (22) the second cylinder (20). The fluid flow (Qp-Qn) flows to the fifth valve (309). The fluid flow (Qn) coming out of the first rod side (12) will add up into flow (Qp-Qn) to get desired fluid flow (Qp) for the first piston side (11) of the first cylinder (10). Remaining fluid flow (Qk-Qp-Qb) along with the returning fluid (Qn) will return to the reservoir (310) through the check valve (330).

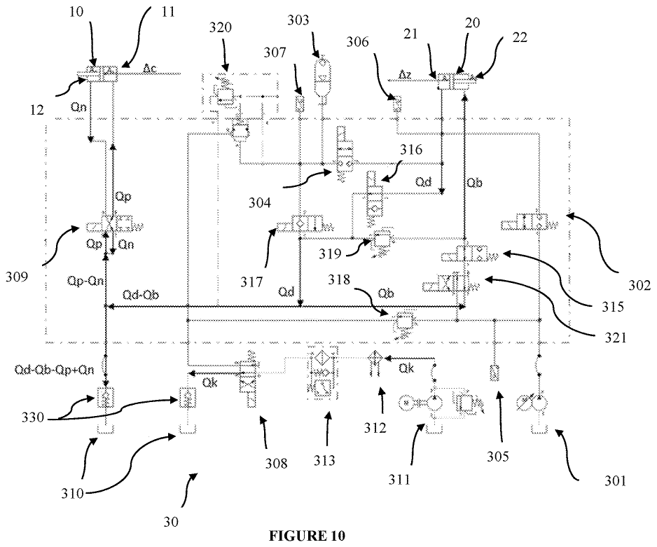

Before clamping force release function, the control unit switches off the second valve (304) to prevent complete energy loss from the accumulator (303). As shown in the exemplified embodiment of FIG. 10, after injection phase is completed, the fourth valve (308) and the second valve (304) are switched off. The fourth Valve (308) will divert flow (Qk) to the reservoir (310) through check valve (330). The control unit switches off the second valve (304) to isolate the accumulator (303) from the second piston side (21) of the second cylinder (20). If the accumulator (303) is not isolated before clamping force release phase, then stored energy inside the accumulator (303) will be lost completely.

As shown in the exemplified embodiment of FIG. 10, during clamping force release phase, the fifth valve (309), the sixth valve (315), the seventh valve (316), the eight valve (317) are actuated. The seventh valve (316) will release high pressure fluid from the second piston side (21) of the second cylinder (20) to the reservoir (310). The fluid (Qd) from the second piston side (21) of the second cylinder (20) is released and passes through the seventh valve (316), wherein a first part of the released fluid (Qb) from the seventh valve (316) is returned to the second rod side (21) of the second cylinder (20) through the ninth valve (321) and the sixth valve (315), a second part of the released fluid (Qd-Qb) is sub-divided into a first sub-divided part of fluid (Qp) is supplied to the first piston side (11) of the first cylinder (10) through the fifth valve (309), and a returning fluid (Qn) through the fifth valve (309) displaced from the first rod side (12) of the first cylinder (10) and a second sub-divided part of the fluid (Qd-Qb-Qp) from the seventh valve (316) is returned to the reservoir (310) through check valve (330).

As shown in FIG. 10, as clamping force is released, the second cylinder (20) will have displacement (Δz) due to release of compressed fluid volume, tie rods length contraction and elastics deformation reversal of platens and mold. Due to displacement (Δz) of the second cylinder (20), the first cylinder (10) will have displacement (Δc). Due to displacement (Δz) of the second cylinder (20), there is transient clamp de-compress flow (Qd) going out from the second piston side of the second cylinder (20). The fluid flow (Qd) is passed through the seventh valve (316) and added to tank line. Based on area ratio of the second piston side (21) to the second rod side (22) of the second cylinder (20), the fluid flow (Qb) is added to the second rod side (22) of the second cylinder (20) to avoid cavitation in the second rod side (22). The fluid flow (Qb) is passed through the sixth valve (315) and ninth valve (321) to reach the second rod side (22) of the second cylinder (20). The remaining fluid flow (Qd-Qb) is diverted to the fifth valve (309) and to the reservoir (310) through check valve (330). The first cylinder (10) has displacement (Δc) which forces the fluid flow (Qn) flowing out of the first rod side (12). Depending on area ratio of the first piston side (11) to the first rod side (12) of the first cylinder (10), the fluid flow (Qp) is added in the first piston side (11) to avoid cavitation due to displacement (Δc). Out of fluid flow (Qd-Qb), the fluid flow (Qp) is supplied through the fifth valve (309). Remaining fluid flow (Qd-Qb-Qp) along with the returning fluid (Qn) is returned to the reservoir (310) through check valve (330).

After the clamping force release phase, the accumulator (303) pressure reduction will be controlled by the eight valve (317) and third pressure transducer (307). Based on the pre-set clamping force and area of the second piston side (21), the clamping pressure Pc is calculated. The accumulator (303) pressure is reduced up to 60-80% of clamping pressure Pc. After reduction of pressure inside the accumulator (303) which is remaining as a residual energy, to be used in next machine cycle to build clamping force (Fₛ). The accumulator (303) having the residual energy as remaining pressure helps to save amount of energy and time required to build the clamping force (Fₛ) during next machine cycle.

As shown in the FIGS. 4-10, between the second pump (311) and the fourth valve (308) a heat exchanger (312) and a filter unit (313) is arranged, wherein the heat exchanger (312) is configured to regulate the temperature of the fluid and the filter unit (313) is configured to filter impurities from the fluid supplied by the second pump (311).

In exemplified embodiments of the fluid system (30), the second pump (311) is a kidney loop filtration power pack. The second pump (311) is supplying fluid to a heat exchanger (312) and a filter unit (313) to remove contamination from fluid and avoid fluid temperature increase beyond allowable operating limits. If the fourth valve (308) is switched off then fluid coming out of the filter unit (313) will be passed through the fourth valve (308) and returns to the reservoir (310) through check valve (330).

As shown in FIGS. 4-10, the check valves (330) spring cracking pressure acts as resistance to push fluid flow (Qp and Qb) to avoid cavitation inside first cylinder piston side (11) and second cylinder piston side (21) respectively.

In the embodiments of the fluid system (30), the first valve (302), the second valve (304), the third valve (314), the fourth valve (308), the fifth valve (309), sixth valve (315), the seventh valve (316), the eight valve (317) and the ninth valve (321) are a direction control valve, wherein said the first valve (302), the second valve (304), the third valve (314), the sixth valve (315), the seventh valve (316) and the eight valve (317) are a zero leak two-port two-position bi-directional valves. The fourth valve (308), the fifth valve (309) and the ninth valve (321) are four-port two-position valves.

The fluid system (30) includes a first pressure relief valve (318), a second pressure relief valve (319) and a third pressure relief valve (320). The first relief valve (318) is capable of protecting the first pump (301) from over-pressurization. The second pressure relief valve (319) protects against over pressurization in the second rod side (22) of the second cylinder (20). The third pressure relief valve (320) protects against over pressurization in the accumulator (303). The first pressure relief valve (318), the second pressure relief valve (319) or the third pressure relief valve (320) can be of a type zero leak pressure relief valve.

The fluid system (30) can employ any fluid, i.e., the fluid system (30) can be based on a hydraulic system or a pneumatic system. The fluid system (30) can be a retrofittable fluid system (30) in the existing clamping unit (1A, 1B, 1C).

The clamping unit (1A, 1B, 1C) allows operator to run larger clamp force requirement molds in smaller clamping force capacity units developed with bigger tie bar (4) distance, larger moving/stationary platen (2, 3) and having lesser amount of fluid in building clamping force. Furthermore, the clamping unit (1A, 1B, 1C) of the present invention increases return of investment of injection molding machines, by allowing to run the bigger size mold in injection molding machine having 5-15% smaller size of clamping unit (1A, 1B, 1C).

It will be appreciated by those skilled in the art that the disclosure is not restricted in its use to the particular application or applications described. Neither is the present disclosure restricted in its preferred embodiment with regard to the particular elements and/or features described or depicted herein. It will be appreciated that the disclosure is not limited to the embodiment or embodiments disclosed, but is capable of numerous rearrangements, modifications and substitutions without departing from the scope as set forth and defined by the following claims.

### LIST OF REFERENCE NUMERALS

1A, 1B, 1C—Clamping unit
2, 7—Stationary platen
3—Moving platen
4—Tie rod
5—Locking assembly
6—Threaded rod
10—First cylinder
11—First piston side
12—First rod side
20—Second cylinder
21—Second piston side
22—Second rod side
30—Fluid system
301—First pump
302—First valve
303—Accumulator
304—Second valve
305—First pressure transducer
306—Second pressure transducer
307—Third pressure transducer
308—Fourth valve
309—Fifth valve
310—Reservoir
311—Second pump
312—Heat exchanger
313—Filter unit
314—Third valve
315—Sixth valve
316—Seventh valve
317—Eight valve
318—First pressure relief valve
319—Second pressure relief valve
320—Third pressure relief valve
321—Ninth valve
330—Check valve

What is claimed is:

1. A clamping unit for an injection molding machine, comprising:
at least one stationary platen and at least one moving platen;
a plurality of tie rods configured to enable the at least one moving platen to linearly move in an axial direction;
at least one first cylinder in fluid communication with a fluid system, the at least one first cylinder configured to move the at least one moving platen in the axial direction towards and away from the at least one stationary platen, the at least one first cylinder having a first piston side and a first rod side;
at least one second cylinder in fluid communication with the fluid system to provide a clamping force, the at least one second cylinder having a second piston side and a second rod side; and
the fluid system comprising:
a first pump;
a first valve, wherein during a clamping phase the first pump provides fluid to the second piston side of the at least one second cylinder through the first valve to build the clamping force;
an accumulator, wherein the accumulator stores an additional fluid received from the second piston side of the at least one second cylinder to dampen pressure intensification due to injection of molten material inside molds;
a second valve, wherein the accumulator receives the additional fluid from the second piston side of the at least one second cylinder or absorbs the fluid from the second piston side of the at least one second cylinder through the second valve; and
a control unit, wherein the control unit is capable of controlling or actuating the first pump, the first valve, and the second valve, and wherein the control unit is capable of storing and releasing energy of the accumulator.

2. The clamping unit as claimed in claim 1, wherein the fluid system includes a first pressure transducer to monitor pressure of the fluid supplied through the first pump, a second pressure transducer to monitor fluid pressure in the second piston side of the second cylinder, and a third pressure transducer to monitor fluid pressure in the accumulator, and wherein the first pressure transducer, the second pressure transducer, and the third pressure transducer transmit the measured pressure to the control unit.

3. The clamping unit as claimed in claim 2, wherein the control unit estimates the pressure difference between third pressure transducer and the second pressure transducer during clamping force build, and wherein when the estimated pressure difference is below a pre-settable value, the control unit actuates the second valve to merge the accumulator with the second piston side of the at least one second cylinder.

4. The clamping unit as claimed in claim 3, wherein the pre-settable pressure difference value is in a range of from 5 bar to 25 bar for a monitoring time of 20 msec.

5. The clamping unit as claimed in claim 2, wherein during the clamping phase, the control unit actuates the first valve to supply fluid to the second piston side of the at least one second cylinder, and wherein the control unit switches off the first valve when the pressure measured by the second pressure transducer is equivalent to generate a pre-set clamping force.

6. The clamping unit as claimed in claim 1, wherein the at least one second cylinder includes a position sensor, the position sensor capable of measuring a position of a piston in the at least one second cylinder, the position sensor configured to transmit the measured position of the piston of the at least one second cylinder to the control unit, the control unit detecting a deviation in measured position of the at least one second cylinder before an injection phase and during the injection phase.

7. The clamping unit as claimed in claim 6, wherein when the position deviation is detected the control unit actuates a fourth valve and a fifth valve to allow the fluid to be supplied to the at least one first cylinder from a second pump.

8. The clamping unit as claimed in claim 7, wherein a part of the fluid from the second pump passes through the fourth valve, a part of the fluid is allowed to pass to the first piston side of the at least one first cylinder through the fifth valve, and a first part of the fluid that passes through the fifth valve and is displaced from the first rod side of the at least one first cylinder along with a second part of the fluid is returned to a reservoir through a check valve.

9. The clamping unit as claimed in claim 7, wherein when the deviation is detected the control unit actuates the fourth valve, the fifth valve, a ninth valve, and a sixth valve to allow the fluid to be supplied to the at least one first cylinder and the at least one second cylinder from the second pump.

10. The clamping unit as claimed in claim 9, wherein the fluid from the second pump passes through the fourth valve, a first part of the fluid from the fourth valve is supplied to the second rod side of the at least one second cylinder through the ninth valve and the sixth valve, a second part of the fluid is allowed to pass to the first piston side of the at least one first cylinder through the fifth valve, and fluid displaced from the first rod side of the at least one first cylinder is returned to a reservoir through the fifth valve along with a third part of the fluid from the fourth valve.

11. The clamping unit as claimed in claim 7, wherein between the second pump and the fourth valve a heat exchanger and a filter unit is arranged, wherein the heat exchanger is configured to regulate the temperature of the fluid and the filter unit is configured to filter impurities from the fluid supplied by the second pump.

12. The clamping unit as claimed in claim 6, wherein fluid from the second piston side of the at least one second cylinder is displaced due to a displacement generated by an injection counter force against the clamping force during the injection phase, a part of the fluid is returned to the accumulator through the second valve and another part of the fluid is returned to the second rod side of the at least one second cylinder through a third valve.

13. The clamping unit as claimed in claim 6, wherein when the fluid from the second piston side of the at least one second cylinder is displaced due to the injection counter force generating the displacement, the fluid is returned to the accumulator through the second valve.

14. The clamping unit as claimed in claim 1, wherein the control unit switches off the second valve before a clamping force release phase to prevent complete energy loss from the accumulator and actuates a third valve, a sixth valve, and a ninth valve, and wherein the fluid from the second piston side of the at least one second cylinder is released and passes through the third valve, wherein a first part of the released fluid from the third valve is returned to the second rod side of the at least one second cylinder, and wherein a second part of the released fluid is sub-divided into a first sub-divided part of fluid that is supplied to the first piston side of the at least one first cylinder through a fifth valve, wherein part of the fluid that passes through the fifth valve is displaced from the first rod side of the at least one first cylinder, and wherein a second sub-divided part of the fluid from the third valve is returned to a reservoir through the sixth valve, the ninth valve, and a check valve.

15. The clamping unit as claimed in claim 1, wherein the control unit switches off the second valve before a clamping force release phase to prevent complete energy loss of the accumulator and actuates a seventh valve and a sixth valve, and wherein the fluid from the second piston side of the at least one second cylinder is released and passes through the seventh valve, wherein a first part of the released fluid from the seventh valve is returned to the second rod side of the at least one second cylinder through a ninth valve and the sixth valve, wherein a second part of the released fluid is sub-divided into a first sub-divided part of fluid that is supplied to the first piston side of the at least one first cylinder through a fifth valve, wherein part of the fluid that passes through the fifth valve is displaced from the first rod side of the at least one first cylinder and a second sub-divided part of the fluid from the seventh valve is returned to the reservoir through a check valve.

16. The clamping unit as claimed in claim 1, wherein the fluid system includes an eighth valve, and wherein the control unit is capable of actuating and switching off the eighth valve to regulate and/or reduce the stored energy of the accumulator.

17. The clamping unit as claimed in claim 16, wherein the control unit switches off the eighth valve when the clamping force intensifies more than 15% of maximum clamping force due to injection counter force.

18. The clamping unit as claimed in claim 16, wherein the accumulator pressure can be reduced up to 60-80% of the clamping pressure, and wherein after pressure reduction, the residual energy stored inside the accumulator is capable of being used to build clamping force during the next machine cycle.

19. A fluid system of a clamping unit, the fluid system comprising:
a first pump configured to provide fluid;
a first valve configured to provide fluid from the first pump to a piston side of at least one cylinder to build clamping force in use of the fluid system;
an accumulator configured to store fluid received from the piston side of the at least one cylinder to dampen pressure intensification due to injection of molten material inside molds in use of the fluid system;
a second valve configured to provide fluid from the piston side of the at least one cylinder to the accumulator; and
a control unit configured to control operation of the first pump, the first valve, the accumulator, and the second valve.

20. A clamping unit for an injection molding machine, the clamping unit comprising:
at least one stationary platen and at least one moving platen;
at least one first cylinder configured to move the at least one moving platen in an axial direction towards and away from the at least one stationary platen, the at least one first cylinder having a first piston side and a first rod side;
at least one second cylinder configured to provide a clamping force, the at least one second cylinder having a second piston side and a second rod side; and
a fluid system in fluid communication with the at least one first cylinder and the at least one second cylinder, the fluid system comprising:
a first pump configured to provide fluid;
a first valve configured to provide fluid from the first pump to the second piston side of the at least one second cylinder to build clamping force;
an accumulator configured to store fluid received from the second piston side of the at least one second cylinder to dampen pressure intensification due to injection of molten material inside molds;
a second valve configured to provide fluid from the second piston side of the at least one second cylinder to the accumulator; and
a control unit configured to control operation of the first pump, the first valve, the accumulator, and the second valve.
